(19) United States
(12) Patent Application Publication
(10) Pub. No.: US 2009/0097829 A1
(43) Pub. Date: Apr. 16, 2009

(54) Video Playback Apparatus

(76) Inventors: Makoto Namekawa, Iwaki-city (JP); Masaru Kimura, Iwaki-city (JP)

Correspondence Address: ALPINE/BHGL, P.O. Box 10395, Chicago, IL, 60610, US

(21) Appl. No.: 12/244,334

(22) Filed: Oct. 2, 2008

(30) Foreign Application Priority Data
Oct. 16, 2007 (JP) 2007-268587

(51) Int. Cl. H04N 5/00

(52) U.S. Cl. 386/126; 386/E05.064

(57) ABSTRACT

Events indicating key operations and commonality of operations to be performed in response to the key operations are registered as common UI events in a common UI event table. In the entry of each of the common UI events, a condition concerning the content of a process that needs to be performed is described as a condition concerning process content. When an HD DVD disk is played back, a navigation manager registers, in each of the entries in the common UI event table, for example, an application or a script that is registered in the HD DVD disk and performs a process that satisfies a corresponding condition concerning process content. When a common UI event has occurred, an application, a script, or the like registered in the entry of the common UI event in the common UI event table is performed.

### RELATED APPLICATIONS

The present application claims priority to Japanese Patent Application Serial Number 2007-268587, filed Oct. 16, 2007, the entirety of which is hereby incorporated by reference.

### FIELD OF THE INVENTION

The present invention relates to a technique for providing commonality of user interfaces in video playback apparatuses that play back video disks in which video content is recorded.

### BACKGROUND OF THE INVENTION

An apparatus is known that converts a first remote control signal to a second remote control signal, and supplies the second remote control signal to a video playback apparatus. This apparatus may be used to convert a remote control signal output from a remote control that is not compatible with a video playback apparatus to a second remote control signal that is compatible with the video playback apparatus. The apparatus then provides the second remote control signal to a playback apparatus to provide a technique for providing commonality of user interfaces in video playback apparatuses that play back video disks in which video content is recorded (see, for example, Japanese Unexamined Patent Application Publication No. 2005-269372). In this technique, a user can control video playback apparatuses of different manufacturers or types through a common user interface using a single remote control.

When video content is recorded in a video disk according to, for example, the High-Definition Digital Versatile Disc (HD DVD)-Video standard or the Blu-ray Disk Movie (BDMV) standard, input keys of a video playback apparatus that accept instructions for various playback operations on the video content from a user can be freely set by the producer of the video content.

Thus, a key operation to be performed by a user to cause a video playback apparatus to perform the same playback operation may vary with the type of a video disk. This is a factor in deterioration in the operability of a video playback apparatus and impairment of user convenience.

Accordingly, it is an object of the present invention to provide, in a video playback apparatus that plays back a video disk in which video content is recorded, commonality of user operations to indicate various playback operations on video content regardless of the type of a video disk.

### SUMMARY OF THE INVENTION

A video playback apparatus according to one aspect of the present invention that plays back a video disk in which video content is recorded and definition information that defines a process of causing the video playback apparatus to perform a predetermined operation is recorded includes a table in which correspondences between user operations and operations to be performed by the video playback apparatus in response to the user operations are registered in a fixed manner, and a user operation handling unit that, in a case where a user operation has occurred, when a process that is defined in the definition information stored in the video disk, which is being played back, and causes the video playback apparatus to perform an operation exists, a correspondence between the operation and the user operation having occurred being registered in the table, performs the process.

In such a video playback apparatus, in a case where correspondences between first user operations, commonality of response operations by the video playback apparatus corresponding to the first user operations being achieved regardless of the type of a video disk, and the response operations are registered in the table in advance, when one of the first user operations has occurred, a process that causes the video playback apparatus to perform a corresponding one of the response operations, out of processes defined in a video disk, is performed. Thus, commonality of a user operation that causes the video playback apparatus to perform a predetermined operation can be achieved.

Such a video playback apparatus may further include a memory that stores default process information that defines default processes that are set in association with respective user operations in a fixed manner. In a case where a user operation has occurred, when a process that is defined in the definition information stored in the video disk, which is being played back, and causes the video playback apparatus to perform an operation does not exist, a correspondence between the operation and the user operation having occurred being registered in the table, and when default process information that defines a default process that is set in association with the user operation having occurred is recorded in the memory, the user operation handling unit may perform the default process according to the recorded default process information.

In this arrangement, in a case where a user operation has occurred, commonality of a response operation corresponding to the user operation being achieved, even when a process that causes the video playback apparatus to perform the response operation is not defined in a video disk, the video playback apparatus can perform the response operation and commonality of the response operation corresponding to the user operation can be achieved.

Moreover, in such a video playback apparatus, in a case where the definition information stored in the video disk defines a process to be activated by a user operation when the video disk is played back, when a user operation has occurred, the user operation handling unit may perform a process that is defined in the definition information stored in the video disk, which is being played back, and causes the video playback apparatus to perform an operation, a correspondence between the operation and the user operation having occurred being registered in the table, by converting the user operation having occurred to a user operation that activates the process and activating the process by the user operation.

Moreover, such a video playback apparatus may further include an input unit that includes a plurality of keys, and each of the user operations may be an operation of a corresponding one of the keys of the input unit.

In such a video playback apparatus, the video disk may be, for example, an HD DVD in which video content is stored according to the HD DVD-Video standard or a Blu-ray Disc in which video content is stored according to the BDMV standard.

Accordingly, in a video playback apparatus that plays back a video disk in which video content is recorded, commonality of user operations to indicate various playback operations on video content can be achieved regardless of the type of a video disk.

### BRIEF DESCRIPTION OF THE DRAWINGS

FIG. 1 is a block diagram of one embodiment of a video playback apparatus;

FIGS. 2A and 2B illustrate tables included in the video playback apparatus of FIG. 1;

FIG. 3 is a flowchart of a method for registering an operation corresponding to a common event; and

FIG. 4 is a flowchart of a method for handling a UI event.

### DESCRIPTION OF THE PREFERRED EMBODIMENTS

A video playback apparatus that plays back HD DVDs storing video content based on the HD DVD-Video standard is described below.

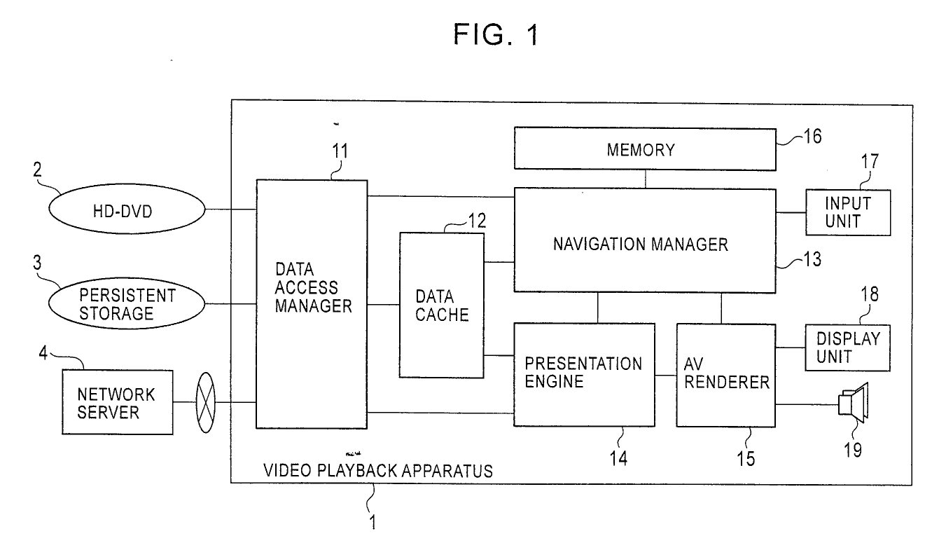

FIG. 1 shows the components of a video playback apparatus. The video playback apparatus 1 may include a data access manager 11, a data cache 12, a navigation manager 13, a presentation engine 14, an audiovisual (AV) renderer 15, a memory 16, an input unit 17, a display unit 18, and a speaker 19.

The video playback apparatus 1 may be a computer that has a general configuration that includes a microprocessor, a memory, and other peripheral devices as hardware. In this case, the components of the video playback apparatus 1, other than the input unit 17, the display unit 18, and the speaker 19, may be implemented as processes implemented by executing, by a microprocessor, a program that is prepared in advance. Moreover, such a program may be supplied to the computer via, for example, a recording medium or an appropriate communication path.

The navigation manager 13 controls playback of a primary video set, a secondary video set, an application, an advanced subtitle, and the like on the basis of a playlist read from an HD DVD 2 via the data access manager 11 and the data cache 12. The presentation engine 14 decodes output images and sounds of a primary video set, a secondary video set, an application, an advanced subtitle, and the like from data obtained from, for example, the HD DVD 2, a persistent storage 3, or a network server 4 in a network under the control of the navigation manager 13. The AV renderer 15 draws and combines the output images decoded by the presentation engine 14 and displays the drawn and combined output images on the display unit 18. The AV renderer 15 further combines the output sounds decoded by the presentation engine 14 and outputs the combined output sounds to the speaker 19.

In this case, a primary video set and a secondary video set are video objects, and an advanced subtitle is a caption object. An application may include a manifesto, a markup, and a script. A manifesto represents information on initialization of an application. A markup defines output images and sounds of an application that are generated using buttons, images, sounds, animations, fonts, and the like. An interactive user interface can be defined using a markup.

A script is a program for controlling various playback operations of, for example, individual applications and the video playback apparatus 1. A script may include, for example, a user interface (UI) event handler script that performs a predetermined process in response to occurrence of a UI event that indicates occurrence of operation of a key of the input unit 17 or a script that is activated by selecting a display object to be displayed according to the definition of a markup, such as a button, in an output image of an application.

Default UI event handler scripts corresponding to individual standard UI events are stored in the memory 16 in the video playback apparatus 1 in advance. In this case, each of the standard UI events indicates occurrence of operation of a key (for example, a “PLAY” key used to issue an instruction to start playback, a “PAUSE” key used to issue an instruction to suspend playback or cancel suspension, or a “SKIP” key used to issue an instruction to change a chapter to be played back) that is selected from keys of the input unit 17 in advance and is presumed to be usually used to issue an instruction to perform a predetermined playback operation regardless of the type of the HD DVD 2. Each of the default UI event handler scripts performs a predetermined process in response to occurrence of a corresponding standard UI event.

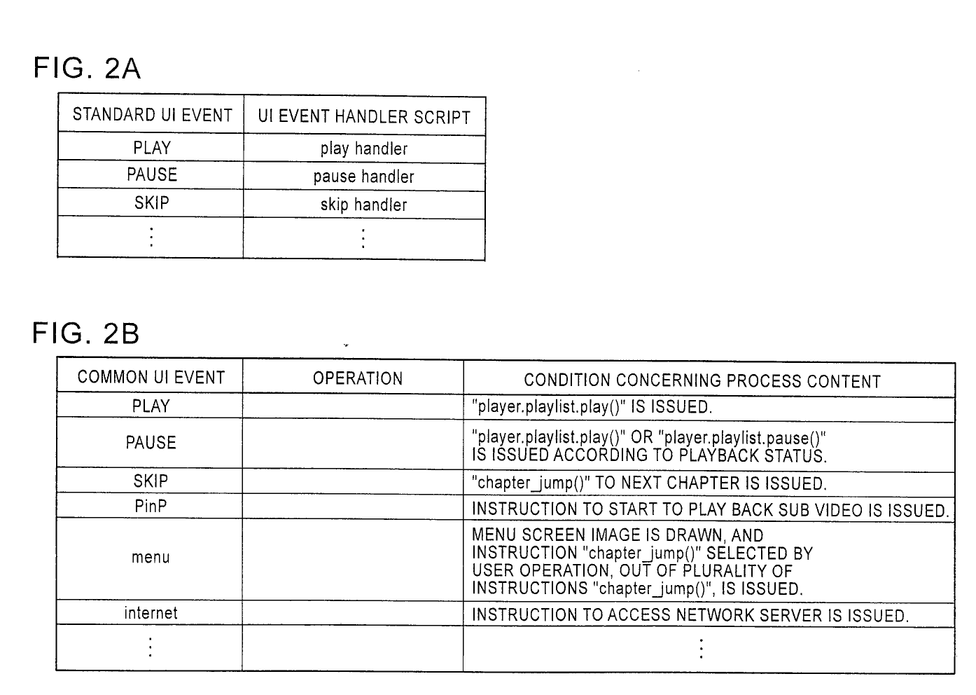

A standard UI event table and a common UI event table are also stored in the memory 16. A standard UI event table may include entries corresponding to respective standard UI events. Further, for each standard UI event entry, the standard UI event table may include a default UI event handler script that is associated with the standard UI event as shown in FIG. 2A.

In a common UI event table, entries corresponding to a plurality of common UI events can be created, as shown in FIG. 2B. In this case, each of the common UI events indicates occurrence of operation of a key (for example, the “PLAY” key used to issue an instruction to start playback, the “PAUSE” key used to issue an instruction to suspend playback or cancel suspension, the “SKIP” key used to issue an instruction to change a chapter to be played back, a “PinP” key used to issue an instruction to display, on a subscreen, sub video included in, for example, a primary video set or a secondary video set, a “menu” key used to issue an instruction to display a menu, or an “Internet” key used to issue an instruction to download content from the network server 4) that is selected from keys of the input unit 17 in advance and needs to be used in common to issue an instruction to perform a predetermined playback operation regardless of the type of the HD DVD 2. An event set as a standard UI event may be registered as a common event.

In each of the entries in a common UI event table, an operation to be performed when a corresponding common UI event occurs can be registered. Moreover, in each of the entries in a common UI event table, a condition concerning the content of a process that needs to be performed in, for example, an application or a script to control a playback operation an instruction for which is accepted in response to a corresponding common UI event is described as a condition concerning process content in advance.

For example, in a case where the “PLAY” key is used in common to issue an instruction to start playback, a condition that an instruction “player.playlist.play( )” to request the start of playback of a playlist needs to be issued when a condition concerning process content is registered as no playback operation is being performed and the condition corresponding to a common UI event indicates operation of the “PLAY” key. Moreover, in a case where the “PAUSE” key is used in common to issue an instruction to suspend playback or cancel suspension, a condition that an instruction “player.playlist.pause( )” to request the suspension of playback of a playlist needs to be issued when a condition concerning process content is registered as a playback operation is being performed and the condition corresponding to a common UI event indicates operation of the “PAUSE” key, and a condition that an instruction “player.playlist.play( )” to request the start of playback of a playlist needs to be issued when a condition concerning process content is registered as a playback operation is being suspended and the condition corresponding to a common UI event indicates operation of the “PAUSE” key. Moreover, in a case where the “SKIP” key is used in common to issue an instruction to change a chapter to be played back, a condition that an instruction “chapterjump( )” to request the jumping to the playback position of the next chapter needs to be issued is registered as a condition concerning process content and the condition corresponding to a common UI event indicates operation of the “SKIP” key.

Moreover, in a case where the “PinP” key is used in common to issue an instruction to display, on a subscreen, sub video included in, for example, a primary video set or a secondary video set, when a condition concerning process content is registered as a condition that an instruction to start to play back sub video needs to be issued and the condition corresponding to a common UI event indicates operation of the “PinP” key. In a case where the “Internet” key is used in common to issue an instruction to download content from the network server 4, a condition that an instruction to access resources in the network server 4 needs to be issued is registered as a condition concerning process content when the condition corresponding to a common UI event that indicates operation of the “Internet” key. In a case where the “menu” key is used in common to issue an instruction to display a menu, a condition that a menu screen that includes a plurality of buttons needs to appear, and the instruction “chapterjump( )” to jump to the playback position of a different chapter corresponding to user operation of one of the buttons needs to be issued is registered as a condition concerning process content when the condition corresponding to a common UI event indicates operation of the “menu” key.

The navigation manager 13 registers an operation corresponding to a common event and handles a UI event to perform a process corresponding to operation of one of the keys of the input unit 17.

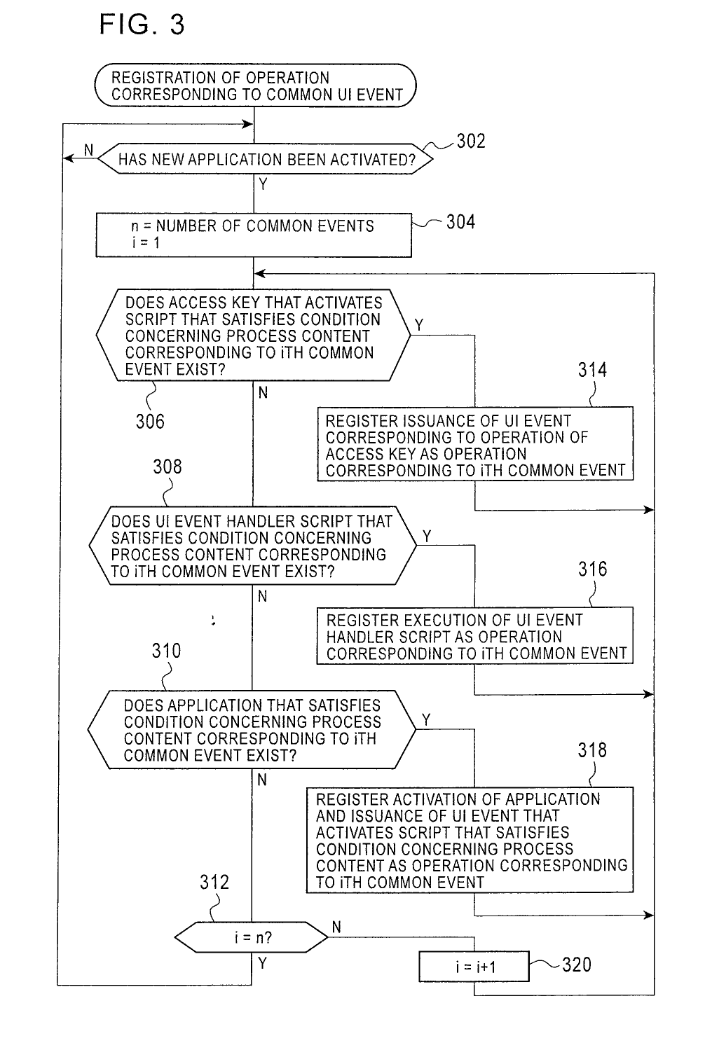

FIG. 3 illustrates one embodiment of a method for registering an operation corresponding to a common event performed by the navigation manager 13. At step 302, it is determined whether a new application has been activated. When it is determined that a new application has been activated, for each of the common UI events registered in a common UI event table, the following steps are performed.

At step 304, the value of a variable n is set to the number of the common UI events, and the value of a variable i is set to one. Then, at step 306, it is determined whether an access key that activates a script that performs a process that satisfies a condition concerning process content registered in the entry of the ith common UI event in the common UI event table is set by the activated application. An access key can be used as a shortcut to select a display object, such as a button, in an output image of an application and is defined by a markup in an application. When it is defined by a markup that a script that performs a process that satisfies a condition concerning process content is activated by selecting a display object through operation of an access key, it is determined that an access key that activates a script that performs a process that satisfies a condition concerning process content exists.

When it is determined that such an access key exists, the process proceeds to step 314. At step 314, generation of a UI event that indicates occurrence of operation of a key that is set as the access key is registered as an operation in the entry of the ith common UI event, and the process regarding the ith common UI event is completed.

On the other hand, when it is determined that such an access key does not exist, the process proceeds to step 308. At step 308, it is determined whether a UI event handler script that handles a UI event and performs a process that satisfies the condition concerning process content registered in the entry of the ith common UI event in the common UI event table exists in the activated application. When it is determined that such a UI event handler script exists, the process proceeds to step 316. At step 316, execution of the UI event handler script is registered as an operation in the entry of the ith common UI event, and the process regarding the ith common UI event is completed.

On the other hand, when it is determined that such a UI event handler script does not exist, the process proceeds to step 310. At step 310, it is determined whether an application that can perform a process that satisfies the condition concerning process content registered in the entry of the ith common UI event in the common UI event table exists. When it is determined that such an application does not exist, the process regarding the ith common UI event is completed. In this case, when an operation that was registered in the past is left in the entry of the ith common UI event, the process regarding the ith common UI event is completed after the operation is erased. Then, the process proceeds to step 312. At step 312, it is determined whether the value of the variable i is equal to the value of the variable n. When it is determined that the value of the variable i is equal to the value of the variable n, the process returns to step 302. Otherwise, the process proceeds to step 320. At step 320, the value of the variable i is incremented by one, and then the process returns to step 306.

On the other hand, when it is determined at step 310 that such an application exists, the process proceeds to step 318. At step 318, the application is analyzed to obtain the sequence of UI events that need to occur to cause the application to perform a process that satisfies the condition concerning process content, and activation of the application and execution of the obtained sequence of UI events are registered as an operation in the entry of the ith common UI event. Then, the process regarding the ith common UI event is completed.

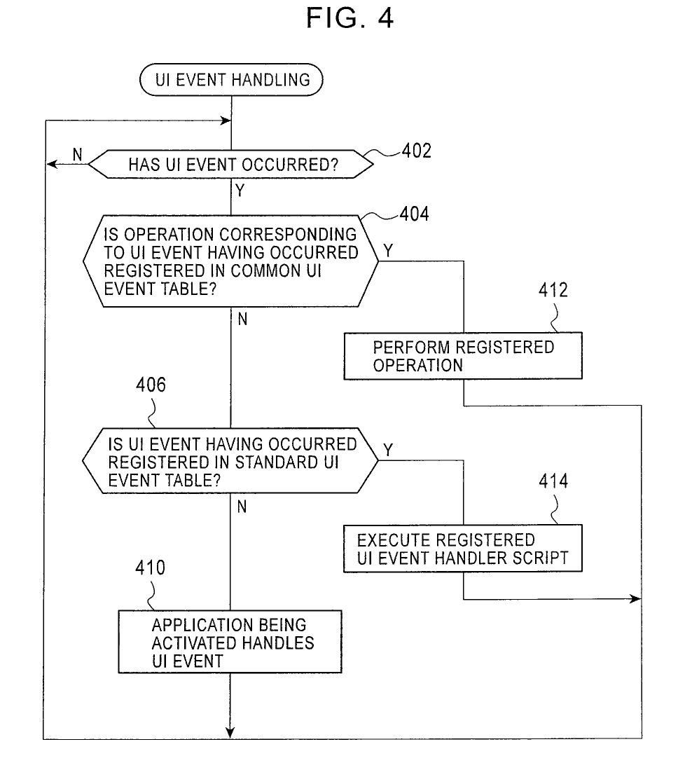

FIG. 4 illustrates a method for handling a UI event performed by the navigation manager 13. At step 402, it is determined whether a UI event that indicates occurrence of operation of one of the keys of the input unit 17 by a user has occurred due to operation of one of the keys of the input unit 17 by a user or execution of an operation in step 412 described below. When it is determined that such a UI event has occurred, the process proceeds to step 404. At step 404, it is determined whether the UI event having occurred, together with an operation, is registered as a common UI event in a common UI event table. When it is determined that the UI event having occurred, together with an operation, is registered as a common UI event in the common UI event table, the process proceeds to step 412. At step 412, the registered operation is performed, and then the process returns to step 402 where occurrence of the next UI event is waited for.

On the other hand, when it is determined at step 404 that the UI event having occurred is not registered as a common UI event in the common UI event table or when it is determined that, although the UI event having occurred is registered as a common UI event in the common UI event table, an operation corresponding to the common UI event is not registered, the process proceeds to step 406. At step 406, it is determined whether the UI event having occurred is registered as a standard UI event in a standard UI event table. When it is determined that the UI event having occurred is registered as a standard UI event in the standard UI event table, the process proceeds to step 414. At step 414, a UI event handler script, corresponding to the standard UI event, that is registered in the standard UI event table is executed, and then the process returns to step 402 where occurrence of the next UI event is waited for.

On the other hand, when it is determined at step 406 that the UI event having occurred is not registered as a standard UI event in the standard UI event table, the process proceeds to step 410. At step 410, when a process to be performed in response to the UI event or a script to be executed in response to the UI event exists in an activated application, the process or script is performed. Then, the process returns to step 402 where occurrence of the next UI event is waited for.

In the registration of an operation corresponding to a common event and UI event handling described above, regarding a key operation that generates a UI event registered in a common UI event table as a common UI event, when a script or an application that performs a process that satisfies a condition concerning process content, corresponding to the common UI event, registered in the common UI event table are recorded in an HD DVD, the script or application performs the process in response to the user operation. The process, which satisfies the condition concerning process content, is performed by the script or application recorded in the HD DVD in this manner. Thus, while the intention of the producer of video content of the HD DVD is achieved as much as possible, commonality of an operation by the video playback apparatus 1 in response to the key operation can be achieved.

Moreover, regarding a key operation that generates a UI event registered in a standard UI event table as a standard UI event, even when the UI event is not registered in a common UI event table or when, although the UI event is registered in the common UI event table, a script or an application that performs a process that satisfies a condition concerning process content is not recorded in an HD DVD, a default UI event handler script registered in the standard UI event table is executed in response to the user operation.

Accordingly, regarding a key operation that generates a UI event registered in a common UI event table or a standard UI event table, commonality of an operation by the video playback apparatus 1 in response to the key operation can be achieved.

While the present embodiment has been described taking, as an example, the video playback apparatus 1, which plays back HD DVDs in which video content based on the HD DVD-Video standard is recorded, the present embodiment can be also applied to the video playback apparatus 1, which plays back Blu-ray Discs in which video content based on the BDMV standard is recorded, in the same manner.

Moreover, the present embodiment can be applied to user operations other than key operations in the same manner. It is therefore intended that the foregoing detailed description be regarded as illustrative rather than limiting, and that it is understood that it is the following claims, including all equivalents, which are intended to define the spirit and scope of this invention.

What is claimed is:

1. A video playback apparatus configured to play back a video disk in which video content is recorded and definition information that defines a process of causing the video playback apparatus to perform a predetermined operation is recorded, the video playback apparatus comprising:
a table in which correspondences between user operations and operations to be performed by the video playback apparatus in response to the user operations are registered in a fixed manner; and
a user operation handling unit that is configured to perform the process defined by the definition information recorded in the video disk when the video playback apparatus plays back the video disk and a user operation occurs that causes the video playback apparatus to perform an operation, wherein the user operation is associated with an operation to be performed by the video playback apparatus in the table.

2. The video playback apparatus of claim 1, further comprising:
a memory that stores default process information that defines default processes associated with respective user operations in a fixed manner,
wherein, in a case where a user operation occurs while the video playback apparatus plays back the video disk, where the user operation is not defined in the definition information information stored in the video disk and is defined by the default process information stored in the memory, the video payback apparatus performs the default process according to the default process information.

3. The video playback apparatus of claim 2, wherein the definition information stored in the video disk further defines a process to be activated by a user operation when the video playback apparatus plays back the video disk, and
wherein, in a case where a user operation occurs while the video playback apparatus plays back the video disk, the user operation handling unit performs a process that is defined in the definition information stored in the video disk and causes the video playback apparatus to perform an operation by converting the user operation to a user operation that activates the process and activating the process, wherein a correspondence between the operation and the user operation is registered in the table.

4. The video playback apparatus of claim 2, further comprising:
an input unit that includes a plurality of keys,
wherein each of the user operations is associated with an operation of a corresponding key of the plurality of keys.

5. The video playback apparatus of claim 2, wherein the video disk is an HD DVD in which video content is stored according to the HD DVD-Video standard.

6. The video playback apparatus of claim 2, wherein the video disk is a Blu-ray Disc in which video content is stored according to the BDMV standard.

7. The video playback apparatus of claim 1, wherein the definition information stored in the video disk further defines a process to be activated by a user operation when the video playback apparatus plays back the video disk, and
wherein, in a case where a user operation occurs while the video playback apparatus plays back the video disk, the user operation handling unit performs a process that is defined in the definition information stored in the video disk and causes the video playback apparatus to perform an operation by converting the user operation to a user operation that activates the process and activating the process, wherein a correspondence between the operation and the user operation is registered in the table.

8. The video playback apparatus of claim 1, further comprising:
an input unit that includes a plurality of keys,
wherein each of the user operations is associated with an operation of a corresponding key of the plurality of keys.

9. The video playback apparatus of claim 1, wherein the video disk is an HD DVD in which video content is stored according to the HD DVD-Video standard.

10. The video playback apparatus of claim 1, wherein the video disk is a Blu-ray Disc in which video content is stored according to the BDMV standard.

11. A computer-readable storage medium comprising a computer program that is read and executed by a computer, the computer program causing the computer to function as a video playback apparatus that plays back a video disk in which video content is recorded and definition information that defines a process of causing the video playback apparatus to perform a predetermined operation is recorded,
wherein the video playback apparatus includes:
a table in which correspondences between user operations and operations to be performed by the video playback apparatus in response to the user operations are registered in a fixed manner, and
a user operation handling unit that is configured to perform the process defined by the definition information recorded in the video disk when the video playback apparatus plays back the video disk and a user operation occurs that causes the video playback apparatus to perform an operation, wherein the user operation is associated with an operation to be performed by the video playback apparatus in the table

12. The computer-readable storage medium of claim 11, wherein the computer program further causes the computer to function as a video playback apparatus further comprising:
a memory that stores default process information that defines default processes associated with respective user operations in a fixed manner,
wherein, in a case where a user operation occurs while the video playback apparatus plays back the video disk, where the user operation is not defined in the definition information information stored in the video disk and is defined by the default process information, the video payback apparatus performs the default process according to the default process information.

13. The computer-readable storage medium of claim 12, wherein each of the user operations is associated with an operation of a corresponding key of a plurality of keys of an input unit of in the computer.

14. The computer-readable storage medium of claim 11, wherein the definition information stored in the video disk defines a process to be activated by a user operation when the video playbackapparatus plays back the video disk,
wherein, in a case where a user operation occurs while the video playback apparatus plays back the video disk, the user operation handling unit performs a process that is defined in the definition information stored in the video disk and causes the video playback apparatus to perform an operation by converting the user operation to a user operation that activates the process and activating the process, wherein a correspondence between the operation and the user operation is registered in the table.

15. The computer-readable storage medium of claim 11, wherein each of the user operations is associated with an operation of a corresponding key of a plurality of keys of an input unit of the computer.

16. A method for processing a user operation that performs a process corresponding to the user operation in a video playback apparatus that plays back a video disk in which video content is recorded and definition information that defines a process of causing the video playback apparatus to perform a predetermined operation is recorded, the method comprising:
determining, in a case where a user operation has occurred while the video playback apparatus is playing back the video disk, whether a process exists that is defined in the definition information stored in the video disk and causes the video playback apparatus to perform a predetermined operation corresponding to the user operation having occurred; and
performing the process in response to determining the process exists in the definition information stored in the video disk.

17. The method of claim 16, further comprising:
performing a default process in response to determining that the process does not exist in the definition information stored in the video disk and identifying the default process that is associated with the user operation.

18. The method of claim 17, wherein each of the user operations is associated with an operation of a corresponding key of an input unit of the video playback apparatus.

19. The method of claim 16, wherein the definition information stored in the video disk defines a process to be activated by a user operation when the video playback apparatus is playing back the video disk, the method further comprising:
converting a user operation that occurs into a user operation that activates an existing process; and
activating the existing process.

20. The method of claim 16, wherein each of the user operations is associated with an operation of a corresponding key of an input unit of the video playback apparatus.
